(19) United States
(12) Patent Application Publication
(10) Pub. No.: US 2015/0261199 A1
(43) Pub. Date: Sep. 17, 2015

(54) CONTROL AND SERVO CONTROL INTERCOMMUNICATOR APPARATUS AND METHOD

(71) Applicants: Raoul Candidi Tommasi Crudeli, Udine (IT); Raffaele Douglas Candidi Tommasi Crudeli, Udine (IT)

(72) Inventors: Raoul Candidi Tommasi Crudeli, Udine (IT); Raffaele Douglas Candidi Tommasi Crudeli, Udine (IT)

(21) Appl. No.: 12/248,767

(22) Filed: Oct. 9, 2008

(30) Foreign Application Priority Data
Oct. 12, 2007 (IT) UD2007A000190

(51) Int. Cl. G05B 19/042; H04W 4/00

(52) U.S. Cl. CPC G05B 19/042; H04W 4/005; G05B 2219/162

(57) ABSTRACT

Control and servo control intercommunicator apparatus, of the type comprising at least input means to detect data from at least one external apparatus connected thereto, means for memorizing and processing said data and means for transmission of the data processed to a remote central command and/or processing system. The apparatus further comprises integrated therein servo control means for said apparatus/apparatuses to be controlled.

### FIELD OF INVENTION

The present invention is directed to the control of remote apparatuses of any kind without needing human intervention on site.

### STATE OF THE ART

At present there are various forms of local or remote instrument control. Schematically they can be divided into three categories:
Modems and communication apparatuses,
Dataloggers (data accumulators),
Dedicated processors.

### 1. Modems and Communication Apparatuses

Modems and passive communication apparatuses have been used for decades with the function of virtualizing the connection between the instrument controlled and a remote computer, so as to render unnecessary the physical (cabled) connection between the two terminals.

### 2. Dataloggers

The function of dataloggers is to sample and store the data arriving from a sensor or instrument, and to memorize them on a local support. Most instruments on the market today are equipped innately with at least one small datalogger, and only function for the devices and brands for which they were devised.

Individual OEM sensors (with direct output) on the contrary are not normally provided with a datalogger.

2.1 Dataloggers with Modem

One evolution of dataloggers is the datalogger with an integrated modem; this apparatus allows to memorize locally the data detected and to send them to a remote server by means of a data connection. Most dataloggers on the market today provide the option of a modem. As for simple dataloggers, these apparatuses are studied to interface only with specific instruments, defined in the design stage.

### 3. Dedicated Processors

Finally, there are advanced dataloggers that integrate processing functions by means of a microcontroller or PLC. As for the previous ones, these processors are created already linked to one or more specific systems and cannot be employed for generic use.

The problems and disadvantages of the state of the art are the lack of a universal application of current devices.

The present invention is aimed to solve the aforementioned problems and disadvantages.

### DISCLOSURE OF THE INVENTION

The purpose of the invention is to solve the above problems and disadvantages and also, without further costs and without reducing reliability:
to improve functionality and performance
to make the apparatus universally applicable, that is, applicable in any condition of interconnection and control.

The problem is solved with the characteristics of the main claims. The dependent claims represent advantageous preferential solutions that provide a better performance.

Particularly, with the present invention:
a) the system is able to govern autonomously, with preset algorithms, the functioning of sensors, electronic and electromechanical apparatuses, sending to one or more servers and/or one or more human operators information concerning the units controlled; the stream of information can occur in real time (streaming) or deferred.
b) the system is made up of different sections, each of which is dedicated to a precise function, but the main benefit derives from using several parts simultaneously. There is a universal control and servo control intercommunicator apparatus, simple, compact and highly functional, able to acquire and process data from:
   analogical sensors (such as for example electronic, environmental, meteorological, optical, electric, electromagnetic sensors, tensions, feeders, photovoltaic panels, batteries etc.);
   digital sensors (such as for example electronic, environmental, meteorological, optical, electric, electromagnetic sensors etc.);
   sensors that communicate with a protocol (such as for example electronic, environmental, meteorological, optical, electric, electromagnetic sensors, sound pressure measurers, phonometers, luxmeters, opacimeters etc.);
   electronic instruments that communicate with a protocol (such as for example apparatuses with autonomous functions);
   electromechanical instruments (such as for example convertors, electric generators, inverters, motors, encoders, etc.).

It is also able to manage:
local analogical outputs;
local digital outputs;
bidirectional protocol communications, local;
electromechanical apparatuses, local;
local communications with PC.

Finally, it can also exchange data by means of remote communication channels;
data exchange via GSM;
data exchange via SMS/MMS;
data exchange via GPRS/UMT/EDGE/G3;
data exchange via Bluetooth.

### BRIEF DESCRIPTION OF THE DRAWINGS

For a better understanding the invention is described in a preferential solution with the help of the attached drawings where:

FIG. 1A is a schematic block view of the main card of the device with its component parts;

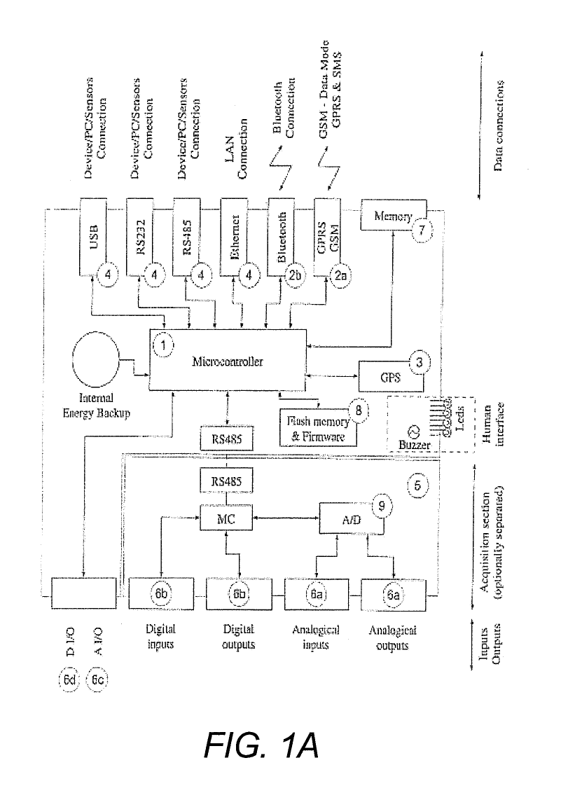

FIG. 1 is a view of the card and the components from the side of the microprocessor;

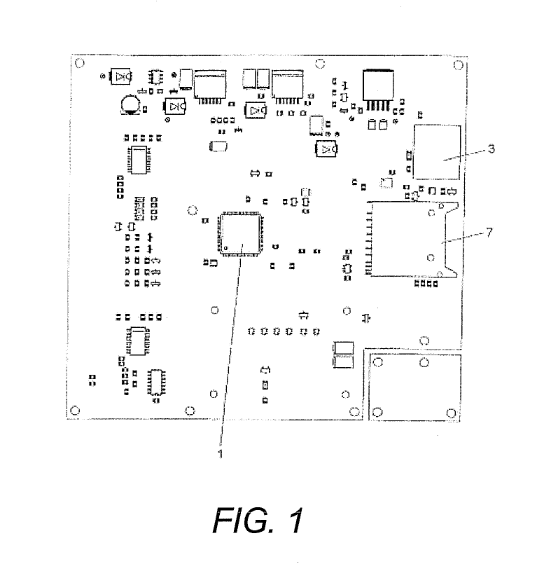

FIG. 2 is a view of the card from the opposite side, showing the respective external connections;

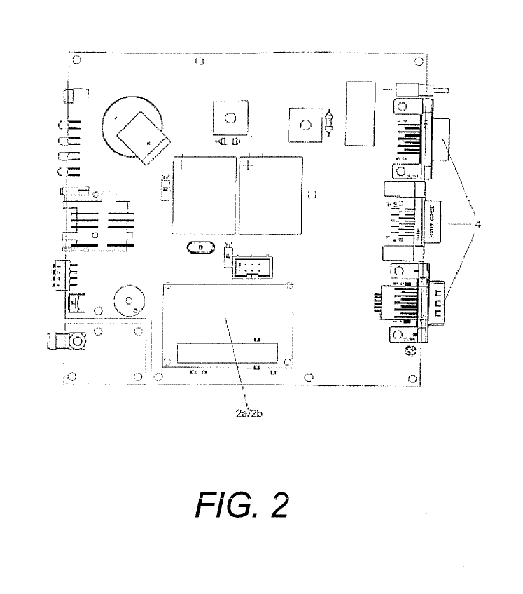

FIG. 3 is a view of the acquisition section made in the form of a separate card with the relative components.

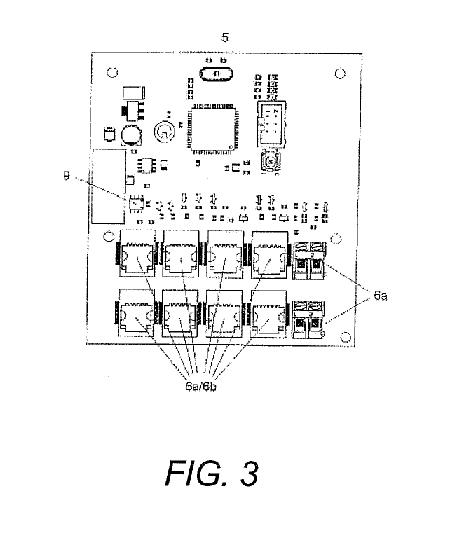

### DETAILED DESCRIPTION OF THE INVENTION

The apparatus according to the invention consists of sections that interface with each other to provide the integrated services used to control in advanced form at least one external device or sensor.

It is also thanks to this modular characteristic that the flexibility is achieved that characterizes the present invention.

Some sections can be omitted without compromising the functions of the others.

In accordance with the drawings it can be seen that the invention concerns a control and servo control intercommunicator apparatus.

The parts have the following reference numbers:
(1) microcontroller
(2a) GSM
(2b) Bluetooth section
(3) GPS
(4) Communication doors
(5) Acquisition section
(6a) analogical inputs and outputs—acquisition section
(6b) digital inputs and outputs—acquisition section
(6c) analogical inputs and outputs
(6d) digital inputs and outputs
(7) Memory
(8) Flash memory containing firmware
(9) A/D converter

Microcontroller Section (1)

The apparatus is based on the microcontroller (1) that manages most of the operations. The microcontroller carries out the instructions of its firmware contained in the flash memory (8), which can be updated from remote; the microcontroller interfaces with the other sections, described in the following paragraphs.

At start-up the microcontroller can perform one or more programs that can reside either in the flash memory (8) or in an external memory (7).

Thanks to the programs that can be executed the system is able to manage autonomously the connections, the analogical/digital inputs and other types of data, and to process data, to pilot external instruments and apparatuses.

The programs for the microcontroller can be written in any supported programming language.

Telephone/Modem Module Section (2a)

The telephone/modem section allows the microcontroller (1) to communicate bidirectionally with at least one remote server and/or at least one human operator.

The data stream can be in any protocol, including
GSM data
SMS or MMS
TCP/IP
UDP
voice

The relative communication channel also allows to pilot the functioning of the unit from remote by at least one server and/or at least one operator, both with precise commands and also by updating the firmware.

The identification card (SIM) of the phone module can optionally be replaced by the apparatus user.

Bluetooth Section (2b)

The Bluetooth section™ allows the microcontroller (1) to communicate bidirectionally with at least one remote server and/or at least one device, exchanging data with them. The communication channel also allows to pilot the functioning of the unit from remote by at least one server and/or at least one operator, both with precise commands and also with updating of the firmware.

GPS Section (3)

A GPS (Global Positioning System) unit, with an antenna which can be either on board or external, allows the system to auto locate itself and also to synchronize its internal clock with GPS time. The microcontroller (1) can process and transmit the information deriving from the GPS section.

Protocol Management Section (4)

The system has at least one protocol communication door, able to manage a data exchange via digital interface. This communication can take place either with a computer or with a digital device. The interface can be, simply to give an example, an RS 232 (EIA Recommended Standard 232), RS 485 (EIA Recommended Standard 485), USB (Universal Serial Bus) 1 or 2, Ethernet (IEEE 802.3), WiFi (IEEE 802.11).

Acquisition Section (5)

The acquisition section samples analogical (6a) and digital (6b) signals at input and transmits the information deduced to the microcontroller (1) which processes it. The analogical data is sampled by an ADC (Analogical-to-Digital Converter) (9).

Other analogical signals (6c) pass directly to the microcontroller (1), where they are sampled on suitable lines.

Other digital signals (6d) pass directly to the microcontroller (1) on suitable lines.

The acquisition section (5) may be on the same card as the main microcontroller or on a secondary card. The microcontroller may manage the acquisition section integrated into the same card and also one, none or several secondary acquisition cards.

Piloting Section (6c and 6d)

The system has an output pilot section, thanks to which it can control external apparatuses and instruments. Piloting can be performed both with digital (6d) and with analogical (6c) signals. The power subsection of the piloting section may be without distinction on board the main card or external thereto. In this case the signals imparted by the main card serve to activate power circuits.

Local Memory Section (7)

The processor can use both in reading and in writing one or more memorization devices (7), either volatile or rewritable, to store information and to access data and programs. The memory support may optionally be replaced by a user.

### Examples of Functioning

The system presented can be used in a variety of situations, according to the data inputs and the connections implemented. Thanks to the programs that can be executed, which can also be loaded remote, it is possible to determine the behavior and advanced logics of the system.

A first example of use is for the management of adverse weather conditions on the road: the system monitors the weather data continuously, follows its development and predicts the moment when the parameters measured or the parameters calculated internally will exceed one or more thresholds. In this way it can activate in advance predetermined signals, both local, such as for example activating optical or acoustic signals, it can activate panels with a variable message, both remote, for example to one or more servers or to one or more operators using one of the interfaces (GSM, SMS or MMS, TCP/IP, UDP, voice, Bluetooth). Thanks to these local prediction signals the management of the road section can, for example, if the system predicts that the threshold of thermal or hygrothermometric safety is about to be exceeded, send gritting means or suchlike to the site, or workers, and/or use other channels to broadcast the updated predictions.

Another example is for the advanced management of instruments without an operator, in which the system is connected to the instruments, it controls them and pilots them, according to predetermined conditions, or determined according to other parameters measured or calculated internally. The system also provides to send content reports, with a settable frequency, to one or more servers and to one or more human operators by means of one of the interfaces (GSM, SMS or MMS, TCP/IP, UDP, voice, Bluetooth). It can also send communications in the event that one or more thresholds are exceeded of one or more parameters measured or calculated internally, or upon request from at least one server or at least one human operator.

Obviously, the above examples are not to be understood in any way as restrictive as they are only given by way of a preferential example.

1. Control and servo control intercommunicator apparatus, of the type comprising at least:
input means to detect data from at least one external apparatus connected thereto;
means for memorizing and processing said data;
means for transmission of the data processed to a remote central command and/or processing system,
and further comprising integrated therein servo control means for said apparatus/apparatuses to be controlled.

2. Control and servo control intercommunicator apparatus as in claim 1, further comprising
a) a microprocessor section as a microcontroller able to manage most of the operations, said microcontroller also being able to carry out the instructions of its firmware from remote; the microcontroller interfacing with the following sections:
b) phone/modem module section, with an identification card (SIM), as bidirectional means of communication with at least one remote server and/or at least one human operator, the stream of data being possible at least by means of GSM data, SMS or MMS, TCP/IP, UDP, voice; said section also being
intercommunication means to pilot the functioning of said external apparatus/apparatuses to be controlled by means of at least one server and/or at least one operator, both with precise commands and also with updating of the firmware
modifiable, the identification card (SIM) being able to be optionally replaced by the system user.
c) protocol management section with respective protocol communication door, able to manage a data exchange via digital interface, said communication can take place either with a computer or with a digital device;
d) acquisition section as a means to sample analogical and digital signals at input and to transmit the information deduced to said microcontroller which processes it, possibly after digital conversion;
e) output pilot section, with the function of controlling said external apparatus/apparatuses to be controlled;
f) GPS section with internal clock and incorporated internal or external antenna, with the function of auto-localization and synchronization of its internal clock;
g) local memory section for storing information and accessing interchangeable data and programs.

3. Control and servo control intercommunicator apparatus as in claim 1, further comprising a Bluetooth™ section connected to the microcontroller which allows it to communicate bidirectionally with at least one remote server and/or at least one device, exchanging data with the latter, and also to pilot the functioning of the unit from remote by at least one server and/or at least one operator, both with precise commands or by updating the firmware.

4. Method for intercommunication, control and piloting of external apparatus/apparatuses using a control and servo control intercommunicator apparatus according to claim 1, the method providing to continuously monitor weather data, following the development thereof and predicting the moment when the parameters measured or the parameters calculated internally exceed one or more thresholds so as to activate in advance predetermined signals, both local and remote, and is able to intervene through reaction by means of said microcontroller and said pilot means.

5. Method for intercommunication, control and piloting of external apparatus/apparatuses using a control and servo control intercommunicator apparatus according to claim 1, the method providing to operate for the advanced management of instruments, without an operator, in which the system is connected to the instruments, it controls them and pilots them, according to predetermined conditions or conditions determined according to other parameters measured or calculated internally, the system also providing to send reports on the content at settable intervals to one or more servers and to one or more human operators by means of one of the interfaces, also being able to send communication s in the event that one or more thresholds of one or more parameters measured or calculated internally are exceeded, or upon request from at least one server or at least one human operator.
